(19) United States
(12) Patent Application Publication
(10) Pub. No.: US 2006/0245860 A1
(43) Pub. Date: Nov. 2, 2006

(54) Cassette storage equipment

(75) Inventors: Susumu Moriya, Shiga (JP); Takayoshi Ono, Shiga (JP)

Correspondence Address: BIRCH STEWART KOLASCH & BIRCH, PO BOX 747, FALLS CHURCH, VA, 22040-0747, US

(73) Assignee: DAIFUKU CO., LTD., Osaka (JP)

(21) Appl. No.: 11/394,095

(22) Filed: Mar. 31, 2006

(30) Foreign Application Priority Data
Apr. 1, 2005 (JP) 2005-106945
Apr. 22, 2005 (JP) 2005-124816

(51) Int. Cl. B65G 1/00

(52) U.S. Cl. 414/279

(57) ABSTRACT

A cassette storage equipment. The cassette storage equipment comprises a cassette storage spatially storing a cassette receiving a plurality of substrates in multiple levels, a transporting unit moving along the cassette storage, comprising a elevating structure and a cassette moving device disposed thereon, and a substrate transporting device transporting the substrate piece by piece to the processing device from the transporting unit. A substrate detecting device is disposed on the elevating structure to obtain a mapping data from the substrates transported form the cassette storage to a cassette on the elevating structure.

### BACKGROUND OF THE INVENTION

1. Field of the Invention

The invention relates to a cassette storage equipment, and more particularly to a cassette storage equipment comprising an automated storage and retrieval warehouse storing cassettes receiving substrates, such as semiconductor substrates and LCD panels, in multiple levels, and a processing device processing the substrates transported from the cassettes.

2. Description of the Related Art

Substrates, such as semiconductor substrates and LCD panels, are processed in production lines. Substrates in a cassette transported from an automated storage and retrieval warehouse by a transporting unit are moved out piece by piece and transported to a next processing device by a robot as disclosed in Japan patent No. 2003-261221 and a transporting device disclosed in Japan patent No. 2003-292149, in which is “substrates are transported from bottom of a cassette by a conveyer capable of moving substrates movable disposed in the cassette.” Not all partitions have substrates in a cassette. The position information of substrates in the cassette, i.e. mapping data of substrates in each cassette, must be given to the robot and the transporting device. The robot and transporting device function automatically according to the mapping data, whereby the empty partitions in the cassette are omitted and the substrates can be transported to the next processing device. A substrate detecting device comprising a detecting sensor detecting substrates in a traverse direction is used to obtain mapping data of substrates in each cassette. Conventional substrate detecting devices, disclosed in Japan patent No. 7-231031, are disposed in the cassette from which the substrates are moved out piece by piece. The substrate detecting device detects positions of substrates in the cassette disposed in a supporting member.

In the described configuration, the cassette storage equipment is arranged in parallel for processing substrates in a cassette transported from an automated storage and retrieval warehouse by a transporting unit. Each cassette storage equipment has a transporting device to transport the substrates piece by piece. Substrate detecting devices disposed in each processing device, however, increases cost. In the processing device, mapping data is not available until the detection is finished. The procedure, from locating the cassette to moving the substrates, is time-consuming.

### BRIEF SUMMARY OF THE INVENTION

An embodiment of a cassette storage equipment comprises a cassette storage 25A and 25B which spatially stores a cassette K receiving a plurality of substrates P in multiple levels, a transporting unit 1 moving along the cassette storage 25A and 25B and comprising an elevating structure 6 and a cassette moving device 7 disposed thereon, a substrate transporting device 31A and 31B transporting the substrate P piece by piece to the processing device 30A and 30B from the transporting unit 1. A substrate detecting device 42 is disposed on the elevating structure 6 to obtain mapping data from the substrates transported form the cassette storage 25A to a cassette K on the elevating structure. 6

The substrate detecting device 42 is disposed on an outer surface of a cassette communication path of the cassette moving device. The substrate detecting device 42 comprises a substrate detecting sensor 47 moveable in a horizontal direction relative to the substrate P transported from the cassette moving device to the cassette K in a predetermined position on the elevating structure 6. The substrate detecting sensor 47 is disposed on a front end of a pendulous element (rock arm 46) swinging horizontally corresponding to a vertical axis. The pendulous element comprises a driving device (actuator 48) driving the pendulous element swinging between a suspending position and an acting position. The suspending position is away from the substrate detecting sensor 47, and the acting position nears the substrates P in the cassette K.

The substrate detecting sensor 47 is disposed on a front end of a moveable element 63 reciprocating in the horizontal direction relative to the substrate P in the cassette K on the predetermined position on the elevating structure 6. The moveable element 63 comprises a driving device (cylinder 64) driving the moveable element 63 reciprocating between a suspending position and an acting position. The suspending position is away from the substrate detecting sensor 47, and the acting position nears the substrates P in the cassette K.

As the cassette moving device 7 is movable in either left side or right side of the elevating structure 6, the substrate detecting device 42 is disposed on an outer surface of an end of a cassette communication path of the cassette moving device 7. The substrate detecting device 42 comprises a substrate detecting sensor 47 fixed on a predetermined position. When the cassette moving device 7 moves to the end of the cassette communication path, the substrates P are detected by the movement of the cassette K.

The elevating structure 6 comprises a turntable 20. The cassette K is exchanged on right or left side of the turntable 20 via a rotation thereof. The substrate detecting device 42 is disposed on the elevating structure 6 without interfering the turntable 20 and the cassette moving device 7.

The elevating structure 6 comprises a turntable 20. The turntable 20 rotates to exchange the cassette K on a right or a left side thereof. The substrate detecting device 42 is disposed on the turntable 20 without obstructing the cassette K to the cassette moving device 7.

The substrate detecting sensors 47 are disposed in a plurality of locations around the substrate P in cassette K in the predetermined position on the elevating structure 6 (a plurality locations corresponding to one side of the substrate P).

The mapping data is obtained by the substrate detecting device 42 detecting the transport of the cassette K containing processed substrate P from the process device 30A and 30B back to cassette storage 25A and 25B.

The cassette storage equipment of the invention actuates the substrate detecting device to detect the cassette on the elevating structure in the transporting unit to obtain mapping data of the substrate during the transport of cassette from the automated storage and retrieval warehouse to the substrate transporting device. Before the cassette is moved to the substrate transporting device, the mapping data has been sent to a robot of the substrate transporting device. The transport of substrate starts immediately without any undesirable wasted time. The cycle time for moving the substrates from the cassette in the substrate transporting device to the processing device is reduced, causing high operation frequency. As a transporting unit have a plurality of substrate transporting devices, it is not necessary to dispose a substrate detecting device in every substrate transporting device to obtain mapping data of the substrates, even in a large apparatus distributing the cassettes to the substrate transporting devices, thus the equipment cost is reduced.

The substrate detecting device is disposed between the elevating structure and the cassette storage without interfering with the cassette moving device. When the substrate detecting sensor is actuated, the substrate detecting sensor approaches the substrates in the cassette. Compact sensors can be used in such a structure rather than certain particular sensor which must function normally when separated from the substrates by a considerable distance. The substrate detecting sensor can reciprocate linearly, whereby the area for constructing the substrate detecting device is reduced. Although the cassette communication path has a narrow space on lateral sides, where the substrate detecting device cannot be installed, the substrate detecting device may be disposed near the cassette.

The cassette communication path does not extend across the elevating structure, but is defined between a predetermined position and one side of the elevating structure. In such a structure, as the substrate detecting sensor enters the cassette automatically and approaches the substrates, the detection is accurately performed even without certain particular sensor which must function normally when separated from the substrates by a considerable distance.

The cassette moving device can be a fork body moving in and out on either the left or the right side of the elevating structure with respect to the center point of the traverse distance of the elevating structure. It is possible for such a fork body to generate wear powder on sliding interfaces. The cassette moving device is, therefore, disposed on the turntable of the elevating structure to enter the cassette moving device only on one side with respect to the center of the turntable (as there is a bearing portion instead of sliding interface, no wear powder is generated). On either side, the cassette is exchanged by rotation of the turntable.

The turntable is rotated so that the left side and the right side of the cassette received in the elevating structure correspond to the left side and the right side of the falling position of the cassette. Rotation can thus be performed during the detection of the substrate.

The substrate detecting device can be disposed on the elevating structure or the turntable of the elevating structure. When disposed on the turntable, although the detection can also be performed during the rotation of the turntable, as the substrate detecting device is connected to certain conventional equipments on the ground, the vibration caused by the moving transporting unit and the elevating structure may result in errors during detection. In such a circumstance, as a plurality of detecting sensors is disposed around the substrates, if the results from the detecting sensors are different, the detection error occurs and redetection is performed automatically to obtain precise mapping data.

Furthermore, the cassette receiving the processed substrates is transported to the automated storage and retrieval warehouse by the same transporting unit. The processed substrates are temporarily stored by priority in transport. In such a condition, the substrate detecting devices in the transporting unit can obtain the mapping data of the processed substrates.

### BRIEF DESCRIPTION OF THE DRAWINGS

The invention can be more fully understood by reading the subsequent detailed description and examples with references made to the accompanying drawings, wherein:

FIG. 1 is a side view of the transporting unit of the invention;

FIG. 2 is a cross section of the transporting unit and cassette storage of the invention;

FIG. 3 is a schematic view of an embodiment of the cassette storage equipment of the invention;

FIG. 4 is a schematic view of another embodiment of the cassette storage equipment of the invention;

FIG. 5 is a cross section of the substrate detecting device of the invention;

FIG. 6 is a front view of the substrate detecting device of the invention;

FIG. 7 is a planar view of another embodiment of the cassette storage equipment of the invention;

FIG. 8 is a front view of the cassette storage equipment of FIG. 7;

FIG. 9 is a rear view of the cassette storage equipment of FIG. 7;

FIG. 10 is a side view of the cassette storage equipment of FIG. 7;

FIG. 11 is a front view of the detecting unit of the cassette storage equipment of FIG. 7;

FIG. 12 is a front view of another embodiment of the cassette storage equipment of the invention; and

FIG. 13 is a side view of the embodiment of the cassette storage equipment of FIG. 12.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

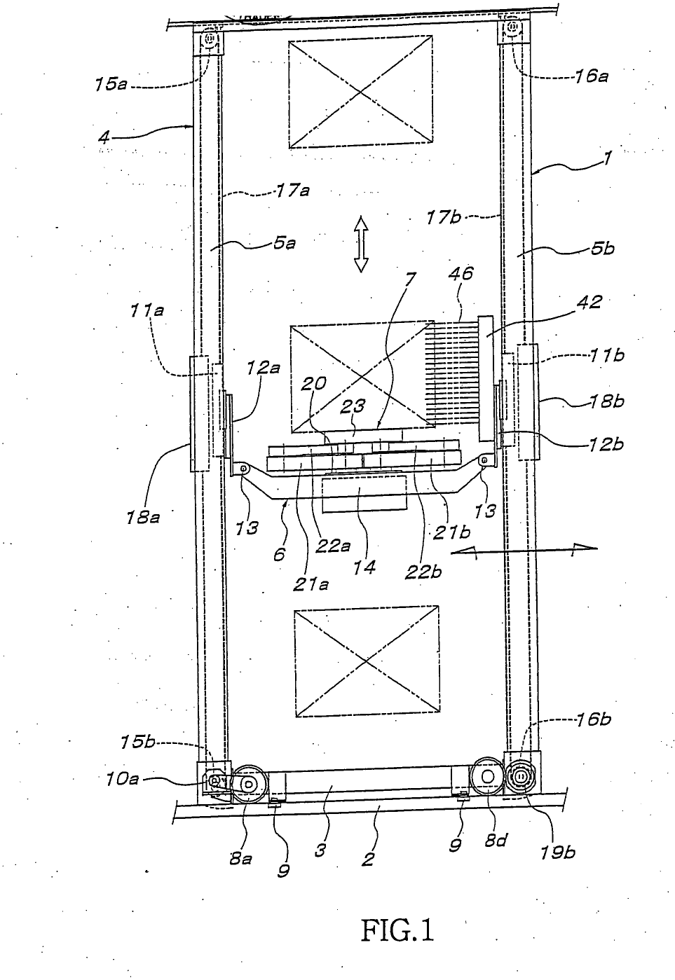

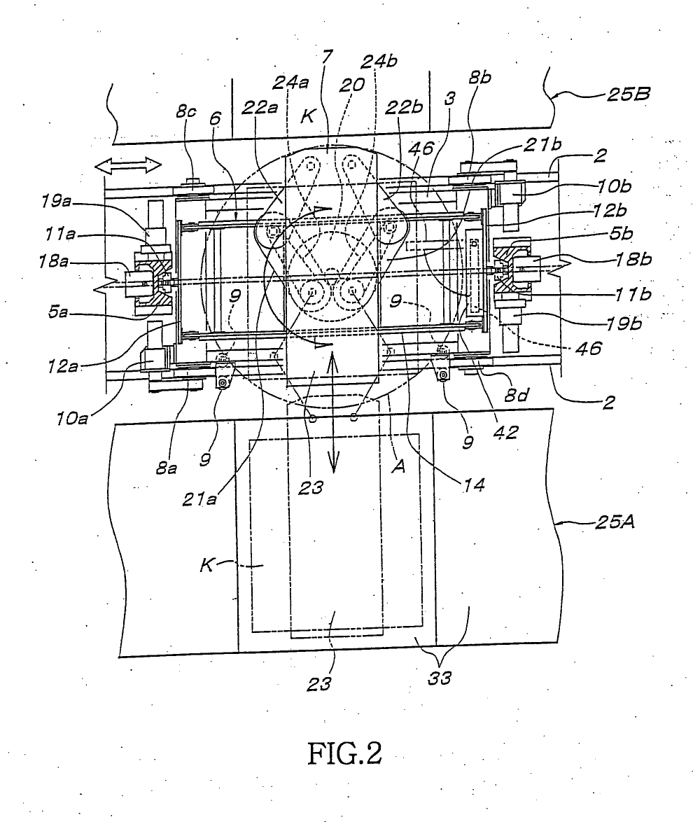

As shown in FIGS. 1 and 2, the transporting unit 1 utilized in an automated storage and retrieval warehouse is substantially a conventional art. A pair of rails 2 allowing a car 3 moving thereon. A door shaped frame 4 is disposed on the car 3. The frame 4 is disposed between a pair of columns 5a and 5b. A cassette moving device 7 is disposed on an elevating structure 6. The car 3 comprises four wheels 8a˜8d and vertical rollers 9. The vertical rollers 9 clamp to rail 2 to reduce vibration. A pair of driving motors 10a and 10b are disposed in a diagonal line of the rectangle formed by wheels 8a to 8d and corresponds to wheels 8a and 8b. Thus, the driving motors 10a and 10b drive the wheels 8a and 8b to move the transporting unit 1 on the rail 2.

The elevating structure 6 comprises a pair of elevating elements 11a and 11b abutting the columns 5a and 5b, and connected to side frames 12a and 12b. A body frame 14 is connected to a horizontal connection axis 13 which is connected to lower ends of the side frames 12a and 12b. Chains 17a and 17b are connected to the gears 15a, 15b, 16a and 16b. The elevating elements 12a and 12b are moved in a direction opposite to a moving direction of weights 18a and 18b. Driving motors 19a and 19b drive the lower gears 15a and 16a. Thus, the chains 17a and 17b moves the elevating structure 6 between the columns 5a and 5b.

The cassette moving device 7 is disposed on a turntable 20. The turntable 20 rotates around a vertical axis on the body frame 14 and comprises a pair of main links 21a and 21b capable of swinging horizontally, a pair of sub-links 22a and 22b capable of horizontal swinging and pivoted to the front ends of the main links 21a and 21b, a supporting fork 23 supported by the front ends of the sub-links 22a and 22b, and a joining devices 24a and 24b joining the main links 21a, 21b and the sub-links 22a, 22b in such a manner that the sub-links 22a and 22b is forced to swing in an opposite direction by the swinging of the main links 21a and 21b.

The cassette moving device 7 is disclosed in JP patent publication number 2002-370184. The main links 21a and 21b and the sub-links 22a and 22b are dogleg-shaped and shown in FIG. 2. The supporting fork 23 is first in an initial position, wherein the main links 21a and 21b are swinging in opposite directions by driving devices. Thus, the joining device 24a and 24b swings the sub-links 22a and 22b is a direction opposite to the swinging direction of the main links 21a and 21b to move the supporting fork 23 in a straight line in FIG. 2.

Then, the supporting fork 23 is located in the center of the elevating structure 6. The main links 21a and 21b are symmetrical to the sub-links 22a and 22b. The main links 21a and 21b and the sub-links 22a and 22b move the supporting fork 23 to a limitated position, wherein the supporting fork 23 protrudes from the sides of the elevating structure 6. The turntable 20 is rotatable clockwise and counter-clockwise by 180 degrees. When the turntable 20 rotates to a first limited position, the supporting fork 23 moves toward a first side corresponding to the moving direction of the transporting unit 1. When the turntable 20 rotates to a second limited position, the supporting fork 23 moves toward a second side corresponding to the moving direction of the transporting unit 1.

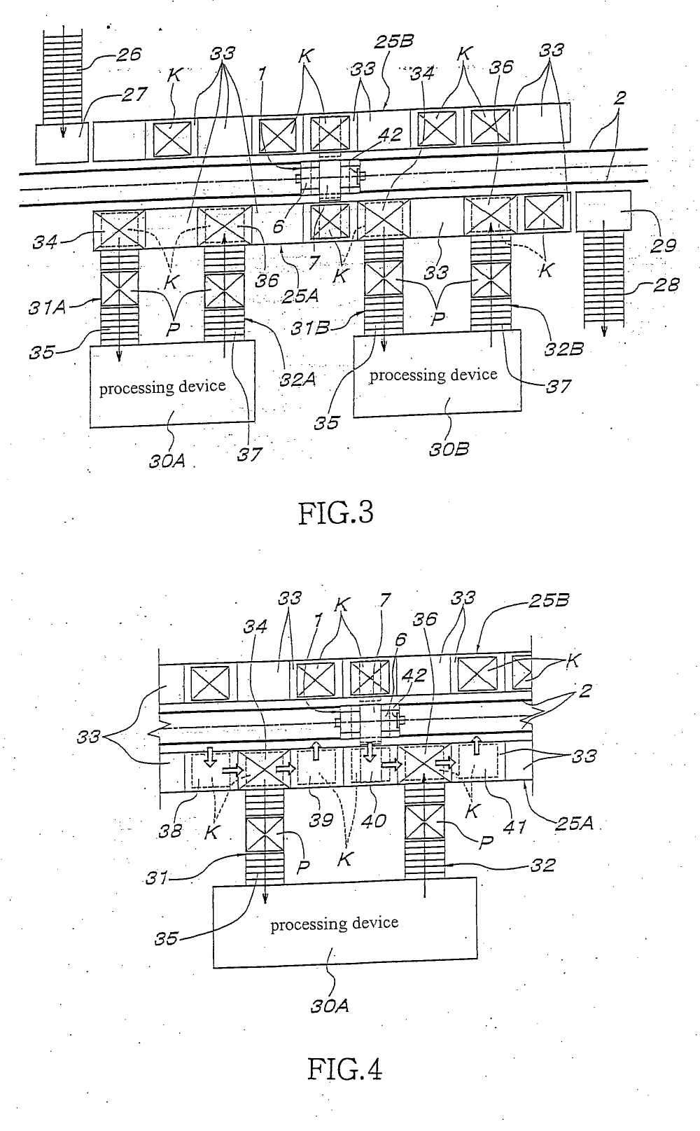

The transporting unit 1 is used in the cassette storage equipment shown in FIG. 3. An input stage 27 connected to an input conveyer 26, an output stage 29 connected to an output conveyer 28, and a plurality of processing devices 30 are disposed in the automated storage and retrieval warehouse, which comprises the transporting unit 1 and the cassette storage 25A and 25B disposed on both sides of the moving path for the transporting unit 1. The substrate transporting devices 31A and 31B and substrate accommodating device 32A and 32B are disposed between the processing device 30A and 30B and the automated storage and retrieval warehouse.

The cassette storage 25A and 25B has a cassette accommodation space 33 for the exchange of the cassettes by the cassette moving device 7. The substrate transporting devices 31A and 31B comprises a substrate drawing portion 34 disposed in the space 33, and a conveyer 35 transporting the processed substrates P to the processing device 30A and 30B. The substrate accommodating device 32A and 32B comprises a substrate accommodation portion 36 disposed in the space 33, and a conveyer 37 transporting the processed substrates P to the substrate accommodation portion 36.

The substrate drawing portion 34 draws the substrates P piece by piece from the cassette K moved from the space 33 to a specific area in the substrate drawing portion 34, and transports the substrates P to the conveyer 35, such as a robot disclosed in Japan patent No. 2003-261221 and a transporting device disclosed in Japan patent No. 2003-292149. As the processed substrates P are inserted piece by piece into an empty cassette K in the substrate accommodation portion 36, the robot disclosed in Japan patent No. 2003-261221 and a transporting device disclosed in Japan patent No. 2003-292149.

In the substrate drawing portion 34, the empty cassette K is moved to and accommodated in the cassette storage 25A and 25B by the transporting unit 1, or moved to the empty substrate accommodation portion 36. The empty cassette K in the cassette storage 25A and 25B can be moved to the substrate accommodation portion 36 by a transporting device which moves the empty cassette K from the substrate drawing portion 34 to the substrate accommodation portion 36.

In the transporting unit 1, cassettes K are directly moved to the substrate drawing portion 34. The substrate accommodation portion 36 receives the cassettes K directly, where the processed substrates P are inserted. In spite of the described structure, in the substrate transporting device 31 shown in FIG. 4, the cassettes K are moved to a cassette accommodating portion 38 by the transporting unit 1. The cassettes K in the cassette accommodating portion 38 are moved to the substrate drawing portion 34, and the empty cassettes K are moved to a cassette accommodating portion 39. In the substrate accommodating device 32, the empty cassettes K are moved to a cassette accommodating portion 40. The empty cassettes K are moved from the cassette accommodating portion 40 to the substrate accommodation portion 36 which has a cassette moving device moving the cassette K with substrates P to a cassette accommodation portion 41. The empty cassettes K and the cassette K with substrates P moved to the cassette accommodating portion 39 are moved to cassette storage 25A and 25B by the transporting unit 1.

The substrate transporting device and the substrate accommodating device are not limited to the described structures. Preferably, the substrates P are moved piece by piece from the cassettes K to the processing device, wherein the cassettes K are moved from the cassette storage 25A and 25B. The processed substrate P is inserted into an empty cassette K piece by piece, which is moved to the cassette storage 25A and 25B. In the invention, although the substrate transporting device is desired, the substrate accommodating device is, however, not necessary. For example, the cassettes K with processed substrates from the processing device are not moved to the cassette storage 25A and 25B, but moved to other processing devices or storage equipments by special transporting devices.

In the described cassette storage equipment, the cassettes K with substrates in the input stage 27 are transported to the empty cassette accommodating space 33 via the transporting unit 1. Based on the demand of the processing device 30A, 30B or the substrate drawing portion 34, the cassettes K are moved from the cassette storage 25A and 25B via the transporting unit 1 to a cassette receiving position in the substrate transporting devices 31, 31A and 31B. The substrate drawing portion 34 moves the substrates P piece by piece from the cassette K to the processing device 30A and 30B. The substrates P are processed in the processing device 30A and 30B, and inserted into the empty cassettes K piece by piece in the substrate accommodation portion 36. The cassettes K with processed substrates P are transported to the cassette storage 25A and 25B via the transporting unit 1. The cassettes K in the cassette storage 25A and 25B are transported to the output stage 29 by the transporting unit 1 and moved out by a conveyer.

The exchange operation between the transporting unit 1, the input stage 27, the cassette accommodating space 33, the cassette receiving position in the substrate transporting devices 31, 31A and 31B, and the substrate accommodation devices 32, 32A and 32B is performed by the movement of the elevating structure 6 for the cassette moving device 7 corresponding to a cassette exchange level, the rotation of the turntable 20 corresponding to the position of device receiving the cassettes, the motion toward the advancing limited position of the supporting fork 23, the movement of the elevating structure 6 for moving the cassettes, and the motion toward the retreating limited position (original) of the supporting fork 23.

The cassettes K transported into the substrate drawing portion 34, with un-processed substrates P, are certainly transported by transporting unit 1 in the previous process. The cassettes K with processed substrates P are transported into the cassette storage 25A and 25B by transporting unit 1. In such a condition, a substrate detecting device 42 shown in FIGS. 1 and 2 is disposed in the transporting unit 1 to obtain the position information, mapping data, of the substrates P in the cassette K.

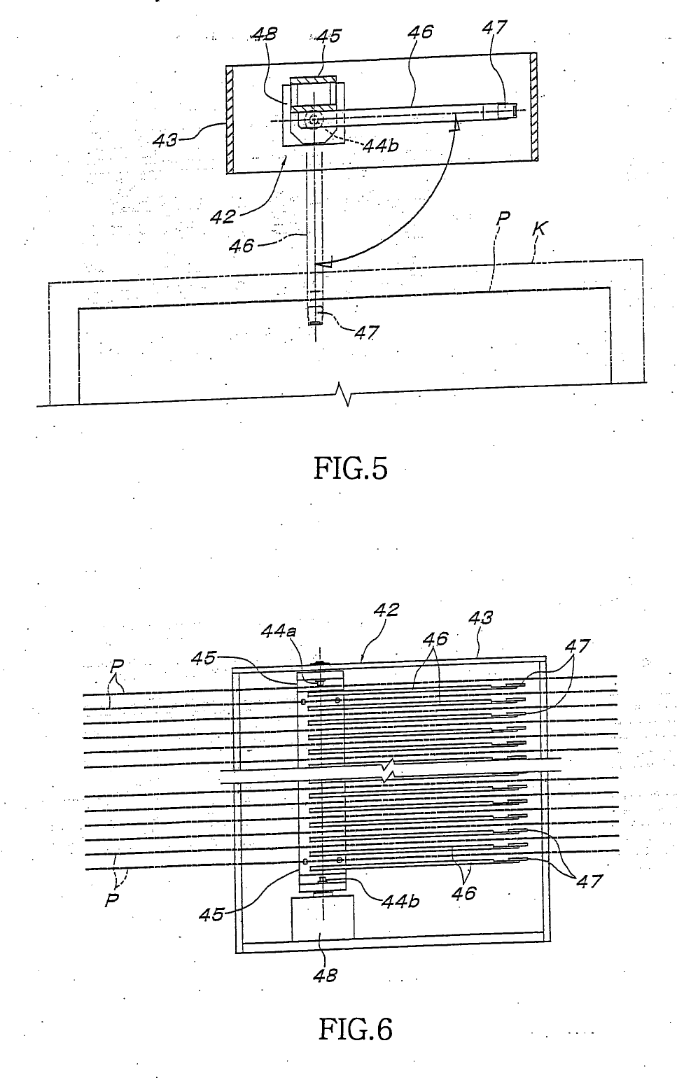

The substrate detecting device 42 is disposed on the inner side of the side frame 12b. When the turntable 20 rotates to exchange the left side and the right side of the supporting fork 23 and the cassette K thereon, the substrate detecting device 42 does not obstruct the supporting fork 23 and the cassette K. The location of the substrate detecting device 42 is outside the rotation area A of the supporting fork 23 and the cassette K as shown in FIGS. 5 and 6. The substrate detecting device 42 comprises a fixed frame 43, a rotatable frame 45 pivoted to the fixed frame 43 on both ends by concentric shafts 44a and 44b, a plurality of traverse extending rock arms 46 with one end disposed on the rotatable frame 45, a plurality of sensors 47 disposed on the front end of the rock arms 46, and an actuator 48 enabling the rotatable frame 45 to rotate between +90° and −90° with respect to the shaft 44b. The actuator 48 can be an electrical motor, a hydraulic or pneumatic cylinder, a hydraulic motor, or a solenoid. To shorten the rock arms 46, the sensors 47 are preferably disposed on a pendulous element swinging with respect to a vertical axis.

According to the substrate detecting device 42, when the cassette K is supported by the supporting fork 23 and pulled to a predetermined position in the elevating structure 6 with the transporting unit 1 moving, and when the cassette K is moved to a cassette receiving position by the cassette moving device 7 (the turntable 20 rotates to exchange the left side and right side of the cassette K), the actuator 48 starts to rotate the rock arms 46 by +90° to approach the cassette K, whereby the sensors 47 are moved to a detecting position near the substrates P.

The substrate detecting device 42 is actuated to move the sensors 47 to a detecting position to detect the partitions of the cassette K with or without substrate P to obtain mapping data of the cassette K. The mapping data of the substrates P in each cassette K is thus available. When the cassette K is transported to the substrate drawing portion 34, the described embodiment can control the substrate drawing portion 34 to move substrates P out piece by piece by, corresponding to the partitions with substrates P in the cassette K.

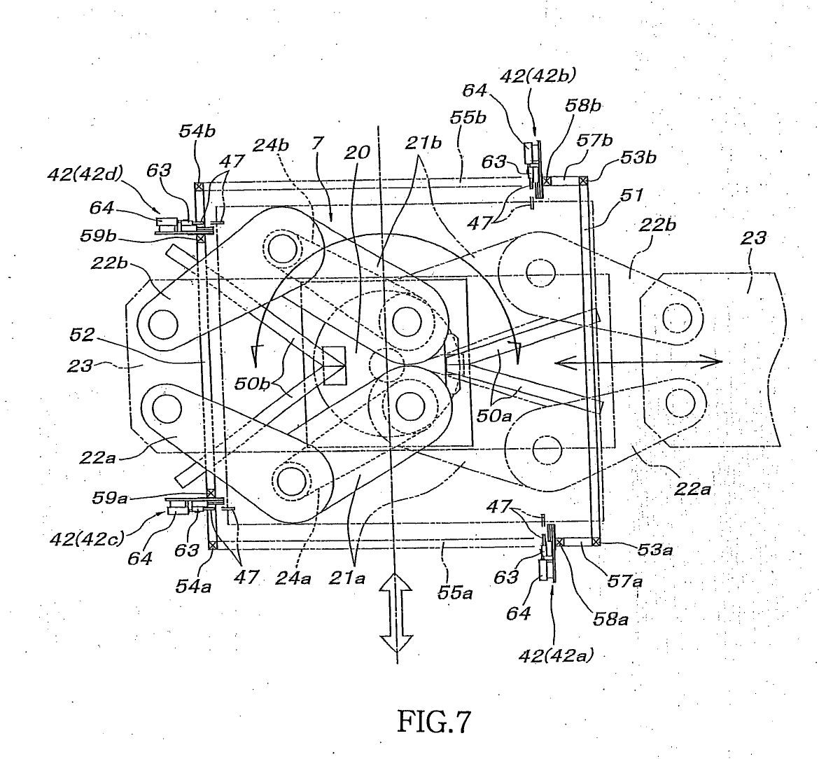

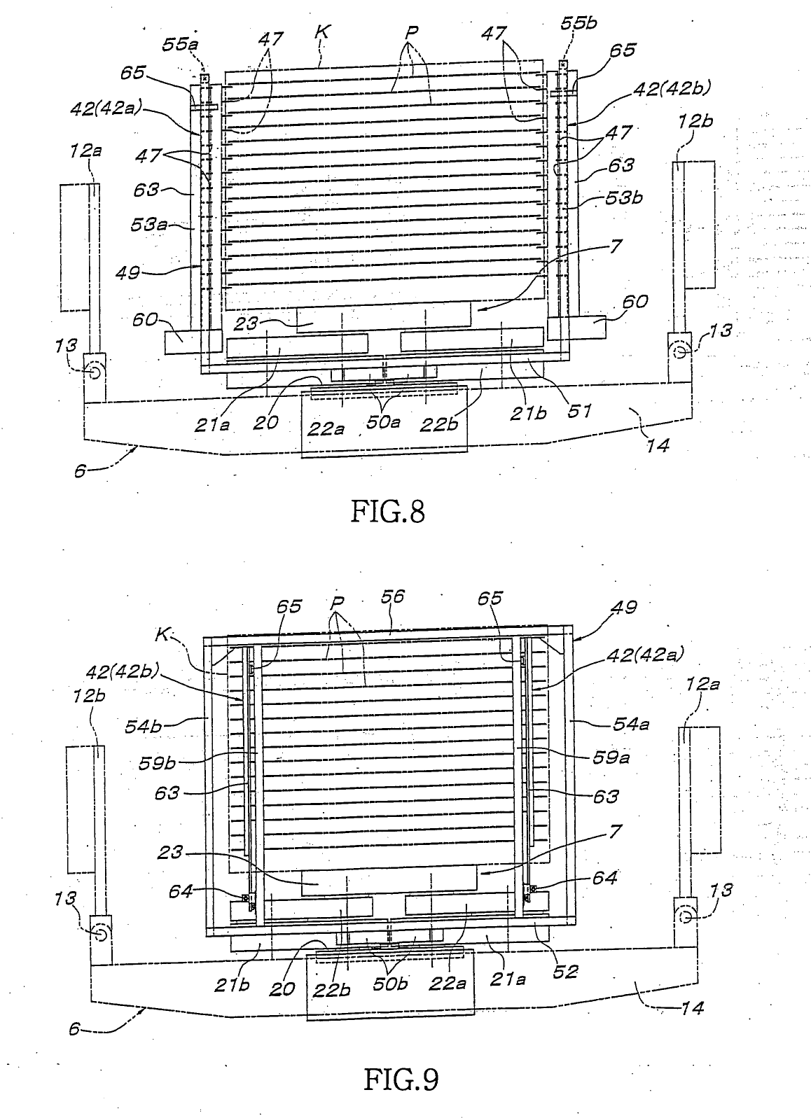

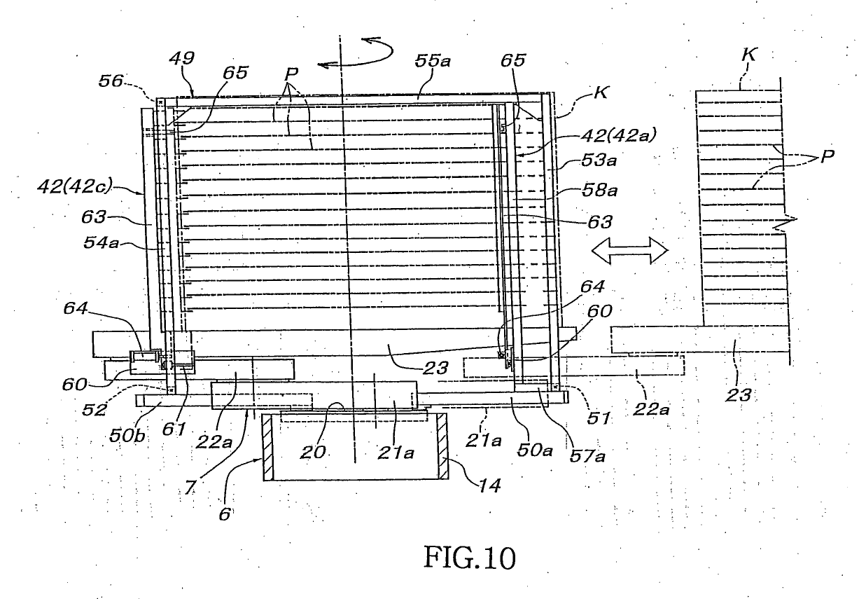

FIGS. 7-11 depict another embodiment of the substrate detecting device 42 disposed on the turntable 20. The substrate detecting device 42 comprises two front detecting units 42a and 42b disposed on opposite sides of the moving direction of the cassette K supported by the supporting fork 23 in the retreating limited position with respect to the turntable 20, and two rear detecting units 42c and 42d disposed on opposite sides contrary to the moving direction of the cassette K supported by the supporting fork 23 in the retreating limited position with respect to the turntable 20. Not all detecting units 42a-42d are necessary.

The supporting frame 49 for the front detecting units 42a and 42b and the rear detecting units 42c and 42d is supported by a frame 50a fixed on the turntable 20 and extending forward and frame 50b fixed on the turntable 20 and extending backward. The supporting frame 49 comprises a front horizontal element 51 supported by the front end of the frame 50a, a rear horizontal element 52 supported by the front end of the frame 50b, columns 53a, 53b, 54a and 54b disposed on the front horizontal element 51 and rear horizontal element 52, horizontal joining elements 55a and 55b disposed between the columns 53a, 54a and between the column 53b, 54b respectively with respect to the cassette communication path, a horizontal joining element 56 disposed between the column 54a and 54b, a supporting post 58a for the front detecting unit with the upper end joined to the horizontal joining elements 55a and 55b and lower end joined to the columns 53a and 53b via the horizontal joining elements 57a and 57b, and supporting posts 59a and 59b for the rear detecting unit between the rear horizontal element 52 and the horizontal joining element 56. The frames 50a and 50b of the supporting frame 49 do not overlap the moving range of the main links 21a and 21b of the cassette moving device 7, and the horizontal elements 51 and 52 are disposed under the moving range of the sub-links 22a and 22b. The elements 53a-59b of the frame 49 are disposed without obstructing the supporting fork 23 and the cassette K thereon moving toward the retreating limited position. The supporting frame 49 is not limited to the structure above.

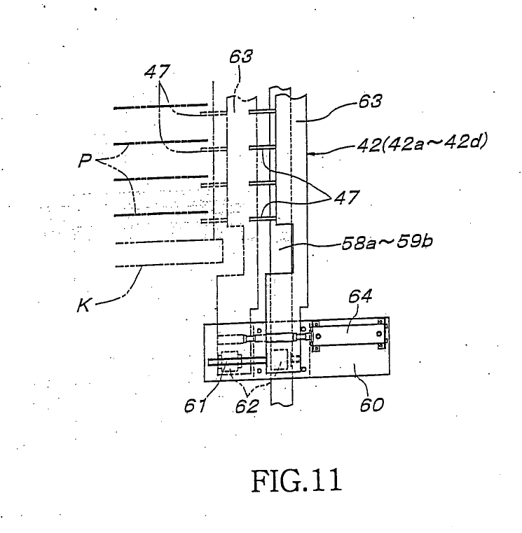

Each detecting unit 42 has the same structure, shown in FIG. 11, which comprises a movable element 63 supported by a rail 61 disposed on a plate 60 and capable of moving on the rail 61 via a sliding element 62, a cylinder unit 64 reciprocating the movable element 63 and disposed between the plate 60 and the movable element 63, and a plurality of sensors 47 disposed on the movable element 63 for detecting the substrates. The movable element 63 comprises a vertical plate disposed perpendicular to the rail 46 relative to the reciprocating direction. The front detecting units 42a and 42b are disposed on the supporting posts 58a and 58b via the plate 60, whereby the reciprocating direction of the movable element 63 is perpendicular to the communication path of the cassette K. The rear detecting units 42c and 42d are disposed on the supporting posts 59a and 59b via the plate 60, whereby the reciprocating direction of the movable element 63 is parallel to the communication path of the cassette K.

When the movable element 63 is in the retreating limited position, the sensors 47 is outside the communication path of the cassette K on the supporting fork 23 without obstructing the cassette K. When the supporting fork 23 is moved to the retreating limited position, the sensors 47 correspond to the substrates P in the partitions of the cassette K. In such a condition, the cylinder units 64 (actuator) of the detecting units 42a-42d are actuated to move the movable element 63 to the advancing limited position, whereby the sensors 47 of the front detecting units 42a and 42b enter the cassette K from the right side and left side and reach two detecting positions on the front end and rear end of sides near the substrates P, and the sensors 47 of the rear detecting units 42c and 42d enter the cassette K from the front side and the rear side and reach two detecting positions on the left end and right end of sides near the substrates P.

When the cassette K is transported to a predetermined position (the supporting fork 23 is moved to the retreating limited position) on the elevating structure 6 from the cassette storage 25A and 25B, the movable element 63 is moved from the retreating limited position to the advancing limited position to move the sensors 47 to the detecting position to detect the partitions of the cassette K. The detection of the substrate detecting device 42 is performed after the cassette K moves to the predetermined position on the elevating structure 6. Detection can also be performed during the rotation of the turntable 20, the movement of the elevating structure 6 and the movement of the transporting unit 1.

In this embodiment, as four detecting units 42a-42d detect the substrate P simultaneously, when the four sensors 47 have the same result (ON represents partitions with substrates, and OFF represents partitions without substrates), the detection is normal, otherwise the detection is abnormal. As the vibration caused by the rotation of turntable 20, the movement of the elevating structure 6 and the movement of the transporting unit 1 can result in abnormal detection, in an abnormal condition, the detection must be repeated to ensure the result. If the abnormal condition still occurs, the substrate detecting device 42 is abnormal. Not all four detecting units 42a-42d are necessary. For example, at least two detecting unit are desirable. In the embodiment of FIGS. 1-6, a pendulous element (rock arm 46) can be a device for changing the positions of the sensors 47. In such a condition, the substrate detecting device 42 with only one detecting unit disposed on the sides of the turntable 20 is employed.

In the structure of the detecting units 42a-42d, the movable element 63 is supported by a supporting unit comprising the plate 60, the rail 61, the sliding element 62 and the cylinder unit 64. In such a condition, to prevent the vibration of the movable element 63, the rail 65 on the top end of the movable element 63 can be disposed on the supporting posts 58a-59b. Although the rails 61 are disposed in parallel on the top and bottom of the cylinder unit 64, for the sake of anti-vibration for the movable element 63, the movable element 63 can be supported only by the supporting unit. The movable element 63 can also be supported by the supporting unit in the longitudinal center thereof. In such a condition, the movable element 63 is supported by the rail 61 at the top and bottom thereof, and moved by the cylinder unit 64. The movable element 63 can be moved linearly by a link mechanism instead of the rail. The actuator is not limited to the cylinder unit 64.

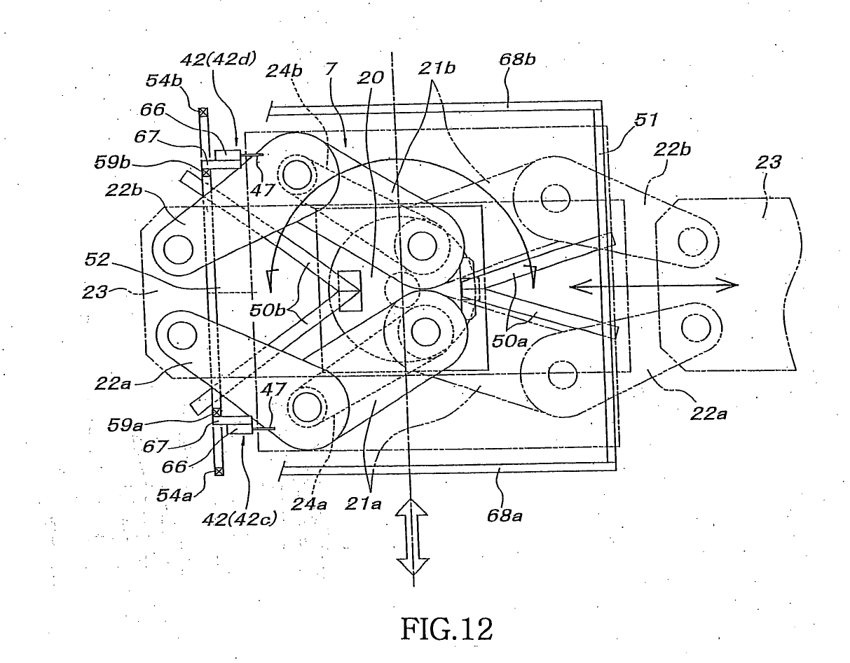

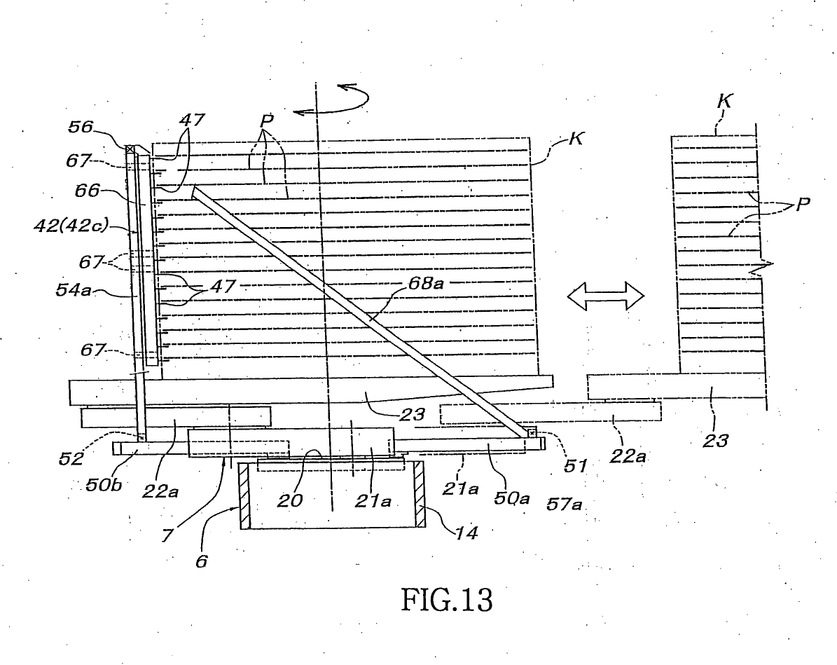

The embodiment shown in FIGS. 12 and 13 is similar to the embodiment shown in FIGS. 7-11, except that only rear detecting units 42c and 42d are used. The rear detecting units 42c and 42d corresponds to a vertical elements 66 (corresponding to the movable element 63 of the previous embodiment) on which the sensors 47 are disposed, and fixed to the supporting posts 59a and 59b via a bracket 67. When the cassette K is moved into the cassette communication path by the cassette moving device 7, the sensors 47 of the detecting units 42c and 42d enters the cassette K for detection.

In this embodiment, the horizontal element 51 is joined to the rear supporting posts 54a and 54b by inclined links 68a and 68b. The elements supporting the front detecting units 42a and 42b are all removed.

In this embodiment, when the cassette K is moved out of the cassette storage 25A and 25B to the elevating structure 6 by the cassette moving device 7, the sensors 47 of the rear detecting units 42c and 42d enter the cassette K. When the cassette K reaches the end position of the communication path, as the sensors 47 reach the detecting position for each partition, even the turntable 20 rotate to exchange the right side and the left side of the cassette K, the sensors 47 can still detect the substrate P to obtain mapping data.

After the cassette K is moved to the destination by the transporting unit 1 and elevating structure 6, when the cassette K on the elevating structure 6 is moved from the transporting unit 1 by the cassette moving device 7, the sensors 47 exit the cassette K and moves as back as possible for not obstructing the cassette K.

In this embodiment, although two detecting units 42c and 42d are disposed in opposite positions corresponding to the back of the cassette K, only one detecting unit disposed in one position corresponding to the back of the cassette K is applicable. The combination of one front detecting unit and one rear detecting unit, i.e. the combination of the detecting units approaching the substrate P in the cassette K in horizontal directions is also applicable.

The sensor 47 can be a photoelectric sensor. The detecting position is near the upper side (or lower side) of the substrate P. Except the sensor 47 for the most upper substrate P, other sensors 47 enter two adjacent substrates P for detection. The kind of sensor 47 is not limited, such as a reflective photoelectric sensor to detect the periphery of the substrate P. In such a condition, the sensors 47 must detect the periphery of the substrates P without entering two adjacent substrates P for detection. The sensor 47 can also be a penetrating type photoelectric sensor with light emitter and light receiver, or a contact type photoelectric sensor.

To correspond to all substrates P in the cassette K, although a plurality of sensors 47 is used to approach all substrates in the embodiment, it is also applicable for only one sensor to move up and down for detection.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A cassette storage equipment, comprising:
a cassette storage, spatially storing a cassette receiving a plurality of substrates in multiple levels;
a transporting unit, moving along the cassette storage, comprising an elevating structure and a cassette moving device disposed thereon; and
a substrate transporting device, transporting the substrate piece by piece to the processing device from the transporting unit, wherein a substrate detecting device is disposed on the elevating structure to obtain a mapping data from the substrates transported form the cassette storage to a cassette on the elevating structure.

2. The cassette storage equipment as claimed in claim 1, wherein the substrate detecting device is disposed on an outer surface of a cassette communication path of the cassette moving device, the substrate detecting device comprises a substrate detecting sensor, moveable in a horizontal direction relative to the substrate transported from the cassette moving device to the cassette in a predetermined position on the elevating structure.

3. The cassette storage equipment as claimed in claim 2, wherein the substrate detecting sensor is disposed on a front end of a pendulous element swinging horizontally corresponding to a vertical axis, the pendulous element comprises a driving device driving the pendulous element swinging between a suspending position and an acting position, the suspending position is away from the substrate detecting sensor, and the acting position nears the substrates in the cassette.

4. The cassette storage equipment as claimed in claim 2, wherein the substrate detecting sensor is disposed on a front end of a moveable element reciprocating in the horizontal direction relative to the substrate in the cassette on the predetermined position on the elevating structure, the moveable element comprises a driving device driving the moveable element reciprocating between a suspending position and an acting position, the suspending position is away from the substrate detecting sensor, and the acting position nears the substrates in the cassette.

5. The cassette storage equipment as claimed in claim 1, wherein the substrate detecting device is disposed on an outer surface of an end of a cassette communication path of the cassette moving device, the substrate detecting device comprises a substrate detecting sensor fixed on a predetermined position, and when the cassette moving device moves to the end of the cassette communication path, the substrates are detected by the movement of the cassette.

6. The cassette storage equipment as claimed in claim 1, wherein the elevating structure comprises a turntable, the cassette is exchanged on a right or a left side of the turntable via a rotation thereof, the substrate detecting device is on the elevating structure without interfering the turntable and the cassette moving device.

7. The cassette storage equipment as claimed in claim 1, wherein the elevating structure comprises a turntable rotating to exchange the cassette on a right or a left side of the turntable, the substrate detecting device is disposed on the turntable without obstructing the cassette to the cassette moving device.

8. The cassette storage equipment as claimed in claim 1, wherein the substrate detecting sensors are disposed around the substrate in cassette in the predetermined position on the elevating structure.

9. The cassette storage equipment as claimed in claim 1, wherein the mapping data is obtained by the substrate detecting device detecting the transport of the cassette containing processed substrate from the process device back to cassette storage.
